(19) United States
(12) Patent Application Publication
(10) Pub. No.: US 2002/0019768 A1
(43) Pub. Date: Feb. 14, 2002

(54) Method and system for managing advertisements

(76) Inventors: James W. Fredrickson, Rocky River, OH (US); Richard D. Williams, Cleveland Heights, OH (US); Charles W. Johnson, Painesville, OH (US)

Correspondence Address: Robert H. Earp, III, 2300 BP Tower, 200 Public Square, Cleveland, OH, 44114-2378, US

(21) Appl. No.: 09/753,210

(22) Filed: Jan. 2, 2001

Related U.S. Application Data
(60) Provisional application No. 60/173,669, filed on Dec. 30, 1999.

(51) Int. Cl. G06F 17/60

(52) U.S. Cl. 705/14

(57) ABSTRACT

This invention includes a method and system for managing advertisements. The method and system of invention utilizes a searchable database containing advertisements accessible by a remote user, choosing the media environment desired for a proposed advertisement, searching said database for advertisements in the chosen media environment, selecting an advertisement and performing any modifications required for the proposed advertisement, and assigning each published advertisement a unique identifier whereby responses can be identified as resulting from a particular published advertisement. This invention also utilizes a database for coordinating the receipt of responses resulting from a particular advertisement, providing an electronic interface response system in communication with the database capable of transmitting pre-qualification questions to a remote source and receiving responses to the pre-qualification questions, and determining the effectiveness of a particular published advertisement based on the number of responses associated with each uniquely identified advertisement. This invention also utilizes the same workflow tools, management tools, and decision support measurements to enhance the timeliness and control of advertisements.

### CROSS REFERENCE TO RELATED APPLICATION

This application claims the benefit of U.S. Provisional Application serial No. 60/173,669 filed on Dec. 30, 2000, and is herein incorporated by reference herewith.

### FIELD OF INVENTION

The present invention relates to a method and system for managing advertisements, and particularly, to efficiently managing the creation, coordination, and publication of effective job placement advertisements a method and system for managing all responses to those job placement advertisements.

### BACKGROUND OF THE INVENTION

Companies commit large amounts of time, money, and man power to deliver their advertising message to their targeted audiences. In particular, companies use vast amounts of resources searching, promoting, and filling available job openings within their company. The traditional method of tediously coordinating and placing advertisements for job openings in numerous cities and states and utilizing many types of media environments is a formidable task. Further, sorting through and evaluating resumes, waiting for walk-in interviews, and reviewing job applications also adds to the frustration of such a large task. And no matter how many or how few job openings a company has, it can be difficult to find enough qualified candidates in the shortest possible time and at the lowest possible cost.

Particularly, companies with large, year-round or seasonal job recruiting challenges require a more effective and efficient method and system for creating, producing, and placing job opening advertisements in all media environments. Such companies are constantly seeking to control the time, money, and man-power spent recruiting employees and the quality of the candidates they interview. Such companies constantly seek a reduction in advertising costs, improved response rates, shortened hiring cycles, and improved human resource staff efficiency.

Further, it is often difficult to evaluate the effectiveness of a job placement advertisement. If the number of qualified responses is too great or too few for a given job opening, valuable resources may have been allocated unevenly to attain the desired response. Further, it is difficult to quickly and effectively compare the efficiency or performance of past recruitment efforts and, in particular, in determining the effectiveness of particular recruitment strategies. Often, an employer is faced with the necessity of committing to a second or more advertisement insertions before being able to analyze the results of the first advertisement. Therefore, there is a need for a better method and system of placing job opening advertisements and evaluating how effective those efforts are.

### SUMMARY OF INVENTION

The method and system of this invention offers the ease of coordinating and placing an advertisement in a variety of media environments through access to an advertisement manager web site over the internet. By selecting a few menu options and indicating certain criteria, an advertisement can be placed according to the specifications and advertising budget of the advertiser to result in the most effective and time/cost efficient advertisement.

The method and system of invention utilizes a searchable database containing advertisements accessible by a remote user, choosing the media environment desired for a proposed advertisement, searching the database for advertisements in the chosen media environment, selecting an advertisement and performing any modifications required for the proposed advertisement, and assigning each published advertisement a unique identifier whereby responses can be identified as resulting from a particular published advertisement. This invention also utilizes a database for coordinating the receipt of responses resulting from a particular advertisement and providing a response system in communication with the database capable of transmitting pre-qualification questions to a remote source and receiving responses to the pre-qualification questions to screen prospective job applicants. Further, this invention is useful in determining the effectiveness of a particular published advertisement based on the number of responses associated with each unique identifier.

The system also measures statistics and responses to provide decision support information for users. The system also provides a robust “tool set” for the electronic control of the workflow and processes associated with the creation, modification, placement, and control of advertisements utilized and accessed through the system.

### BRIEF DESCRIPTION OF THE DRAWINGS

FIG. 1 is a screen shot of a sample login page which may be used for this invention;

FIG. 2 is a screen shot of a sample advertisement manager home page shown which may be used for this invention;

FIG. 3 is a screen shot of a sample Select Media Screen which may be used for this invention;

FIG. 4 is a screen shot of a sample Selection Options page which may be used for this invention;

FIG. 5 is a screen shot of a sample Master Catalog which may be used for this invention;

FIG. 6 is a schematic diagram advertisement manager of this invention;

FIG. 7 is a schematic diagram of the ad production process of this invention;

FIG. 8 is a schematic diagram of the new advertisement ordering process for newspapers;

FIG. 9 is a screen shot of a sample Previous Insertions page which may be used for this invention;

FIG. 10 is a screen shot of a sample Detail Results page which may be used for this invention;

FIG. 11 is a screen shot of the Previous Insertions: Date Range page which may be used for this invention;

FIG. 12 is a screen shot of the Individual Previous Insertions Page which may be used for this invention;

FIG. 13 is a screen shot of the Select Copy page which may be used for this invention;

FIG. 14 is a screen shot of a sample Locations and Positions page which may be used for this invention;

FIG. 15 is a screen shot of a sample Select Publications page which may be used for this invention;

FIG. 16 is a screen shot of a sample “State” Media Search page which may be used for this invention;

FIG. 17 is a screen shot of a sample Select Publication page utilized with the City and State media search which may be used for this invention;

FIG. 18 is a screen shot of a sample Outlets page which may be used for this invention;

FIG. 19 is a screen shot of a sample Select Insertion Dates page which may be used for this invention;

FIG. 20 is a screen shot of a multiple locations Location and Positions page which may be used for this invention;

FIG. 21 is a screen shot of a sample Openings page which may be used for this invention;

FIG. 22 is a screen shot of a sample Insertion Order page which may be used for this invention;

FIG. 23 is a screen shot of a sample Insertion Order page for an In-column ad which may be used for this invention;

FIGS. 24 and 25 are screen shots of a sample Order Confirmation page which may be used for this invention;

FIG. 26 is a screen shot of a Master Catalog page for radio advertising which may be used for this invention;

FIG. 27 is a screen shot of a Master Catalog page for a Television spot which may be used for this invention;

FIG. 28 is a screen shot of a Billboard page which may be used for this invention;

FIG. 29 is a screen shot of a Posters page which may be used for this invention;

FIG. 30 is a screen shot of a Direct Mail page which may be used for this invention;

FIG. 31 is a screen shot of a Miscellaneous Media Order page which may be used for this invention;

FIG. 32 is a screen shot of a sample Check Order Status page which may be used for this invention;

FIG. 33 is a screen shot of a sample Specific Order Status page which may be used for this invention;

FIG. 34 is a screen shot of a sample Current Week's Results page which may be used for this invention;

FIG. 35 is a screen shot of a sample Individual Advertisement's Current Week's Results page which may be used for this invention;

FIG. 36 is a screen shot of a Select Insertion Dates page which may be used for this invention;

FIG. 37 is a screen shot of a Select Publications page which may be used for this invention;

FIG. 38 is a screen shot of a Select Advertisements page which may be used for this invention;

FIG. 39 is a screen shot of a sample Placement History page which may be used for this invention; and

FIG. 40 is a screen shot of a sample Individual Advertisement Placement History page which may be used for this invention.

### DETAILED DESCRIPTION OF INVENTION

The present invention provides for a method and system for managing the placement and evaluation of advertisements. And although the preferred embodiment of this invention is utilized in the coordination, placement, and evaluation of job opening advertisements, it would be obvious to a person skilled in the art that this invention could be utilized in other areas of advertising where increased advertisement coordination, creation, or placement is needed. This invention can also be utilized in more closely and efficiently analyzing responses to particular advertisements. This invention is most useful for large, multi-location employers seeking control of, and decision support for, recruitment advertising needs in many different locations spread across many different job openings (i.e. Delta Airlines®, McDonalds®, and UPS®). And although this invention clearly addresses the needs of these large, multi-location customers, this invention likewise addresses the needs of smaller business.

In the preferred embodiment, this invention includes a method and system for managing job placement advertisements. This invention utilizing a searchable database and “electronic ad book” containing advertisements accessible by a remote user and the ability to choose the media environment desired for a proposed advertisement, search the database for advertisements in the chosen media environment, and select an advertisement and perform any modifications required for the proposed advertisement. Prior to publication of the advertisement, each particular advertisement in each media environment is assigned a unique identifier whereby responses thereto can be identified as resulting from a particular published advertisement. This invention also utilizes a database for coordinating the receipt of responses resulting from a particular advertisement and providing a response system in communication with the database capable of transmitting pre-qualification questions to a remote source and receiving responses thereto. This invention can further evaluate whether job applicant candidates are qualified based upon the responses given and thereby determine the effectiveness of a particular published advertisement based on the number of qualified responses associated with each unique identifier. Following is a detailed description of the method and system of this invention.

This invention is utilized using an advertising manager web site accessible through a URL address on the internet. The coordination, creation, and placement of advertisements can be implemented over the internet. The system is connected to and interacts with an electronic system controlling the pre-qualification of candidates through the use of an internet web site or an interactive voice response system (IVR). Responses to specific advertisements can be evaluated and coordinated in a central database based upon minimum criteria required by the company. The description that follows describes the utilization of the advertising manager web site accessible by a company employee, a human resources person, or other designated end user (hereinafter referred to as “user”) to coordinate, create, and place advertisements. The description further describes the utilization of the response system to measure the interactions of prospective job applicants and gather information regarding the effectiveness of a particular advertisement.

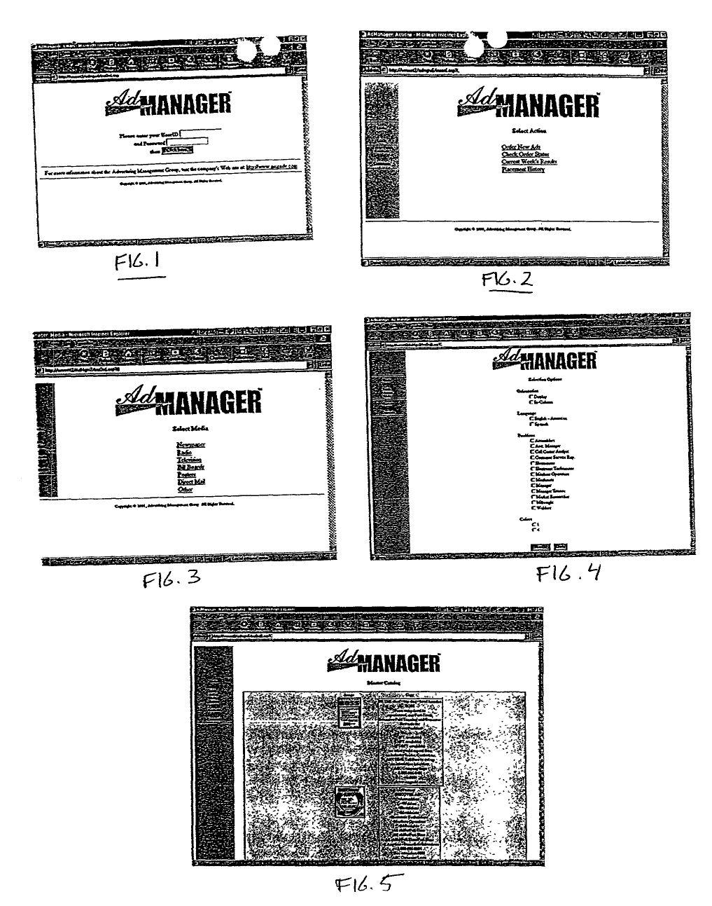

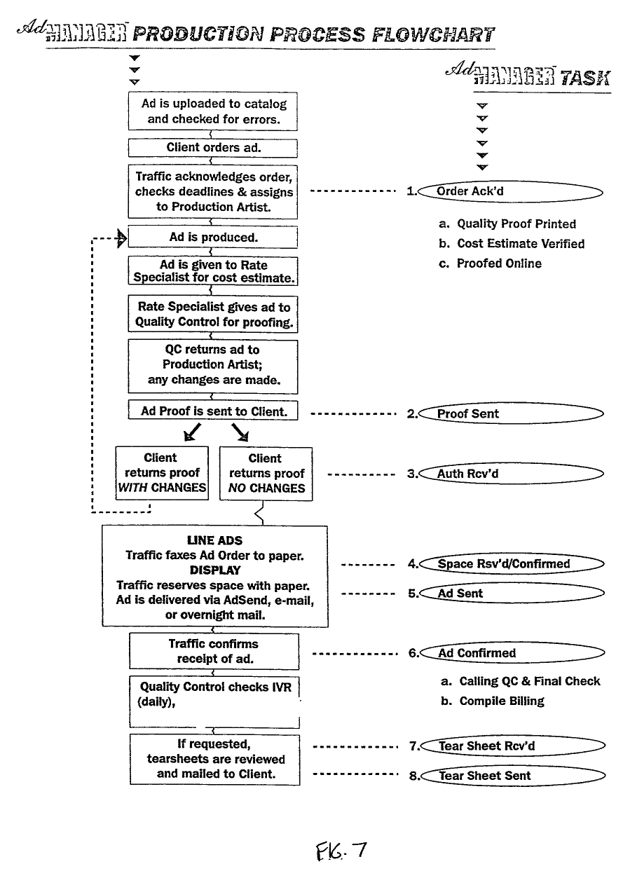

To gain access to the password protected advertisement manager internet site, a user enters a user ID and password in the appropriate areas in the login page shown in FIG. 1. Doing so will take the user to the advertisement manager home page shown in FIG. 2. The advertisement manager home page gives the user an opportunity to perform several different actions that range from ordering new advertisements to viewing placement results (a schematic of which is shown in FIG. 6). To select an action, the user can click on the desired link to be connected to the page that guides the user through the desired functions. The links are explained in detail in the following sections.

Select Copy—Intellicopy Information

Before the user is able to order an advertisement, the production staff will “upload” a catalog ad to offer as much automation as possible. The advertisements will contain combinations of predetermined drop-down menus, check boxes, editable text and fixed text to enhance the ad production process. This allows the user to order their advertisement quickly and efficiently. The drop-down menus can allow the user to choose positions and locations for the advertisement that correspond with the IVR. (The advertisement manager production process is shown in FIG. 7).

Ordering New Ads

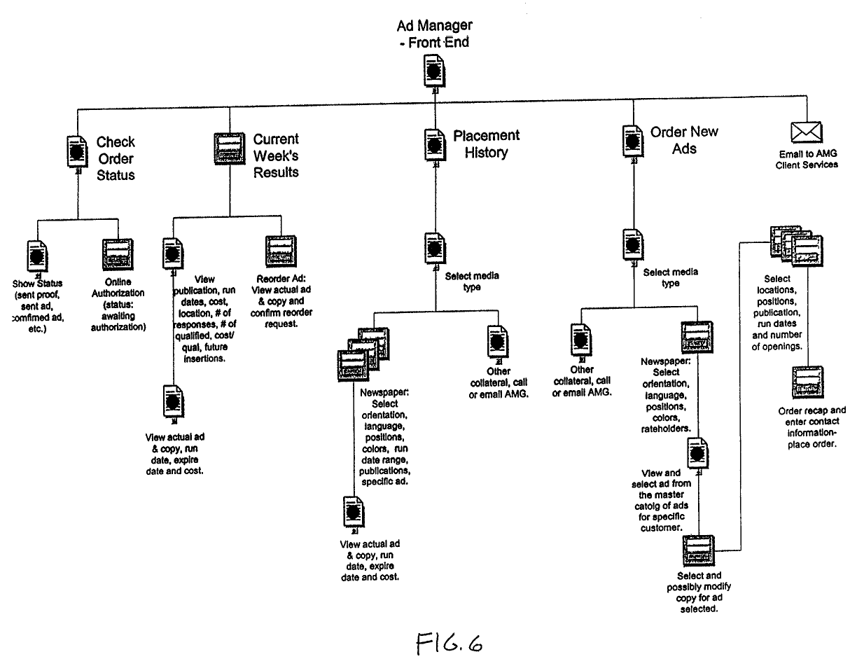

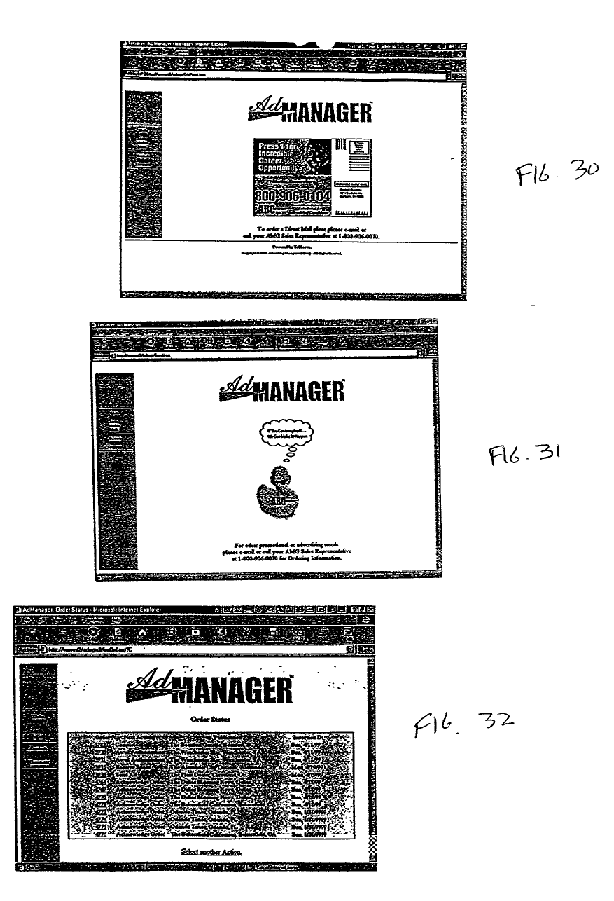

Once the “Order New Ads” link is selected, the user will see an array of menu options for placing advertisements in different media environments in the Select Media Screen in FIG. 3. Media environments utilized in this invention include, but are not limited to, newspaper, radio, television, billboards (FIG. 28), posters (FIG. 29), on-line job postings, and direct mail (FIG. 30). Because the order placing process is similar with regard to all media environments, only a detailed description of the order placing process for newspaper advertisements is included. Other media environments may be order using the Miscellaneous Media Order page shown at FIG. 31. By choosing the Newspaper link from the Select Media page, the user chooses to place an advertisement or advertisements in a newspaper. Choosing the Newspaper link will connect the user with the Selection Options page. A schematic diagram of the advertisement ordering process is shown in FIG. 8.

The Selection Options page, shown in FIG. 4, allows the user to specify what type of advertisement they would like to place. In selecting advertisements having the specified criteria, the user can identify prior created or published advertisements meeting the specified criteria to narrow the possible extensive catalog choices. Only those advertisements relevant to the particular media environment and selection criteria chosen will appear on the next page. To display the entire user catalog of advertisements, the user could not select any options and click on the Search button. To activate these options for narrowing the advertisement search, the user can click on the box located on the left side of each option. The same action is used to deactivate the options. The options to narrow the advertisement search include, but are not limited to, specifying the target audience, advertisement orientation, language, employment position, and colors for the advertisement.

The target audience option indicates the specific market for which the advertisement focuses. The orientation option indicates the type of newspaper advertisement desired. The language option indicates in what language the advertisement is printed. The job positions option indicates the type of employment position for which the advertisement focuses. The colors option indicates the number of colors desired in the advertisement. Once the user has made the desired selections, the user can click on the Clear button to clear the choices and start over or click on the Search button to view the Master Catalog of newspaper advertisements that meet the selected criteria.

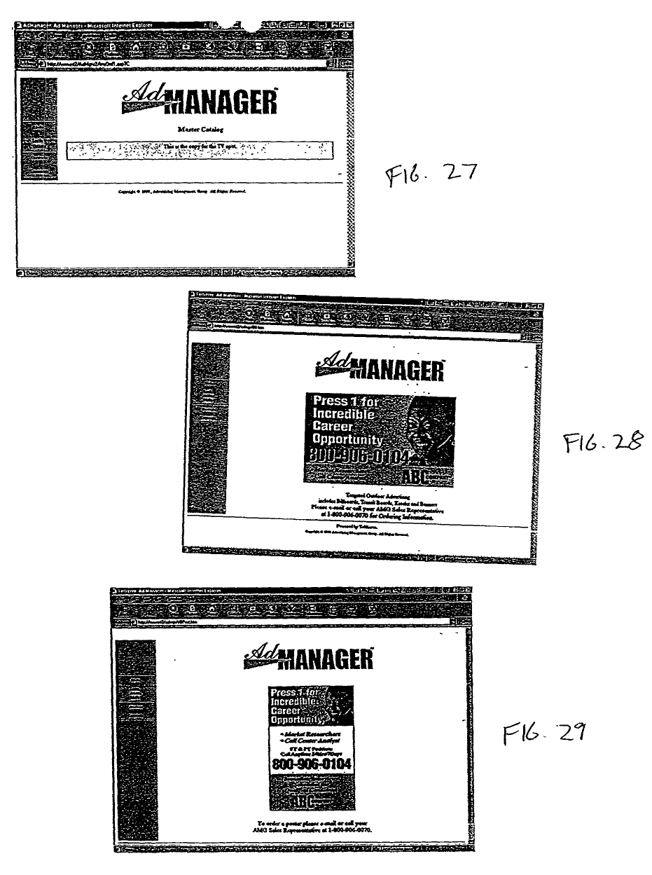

The Master Catalog, shown at FIG. 5, is the main listing of newspaper advertisements (FIG. 26 shows a Mater Catalog for radio, FIG. 27 shows a Master Catalog for Television spots) that meet the selected criteria from the Selections Options page. The Master Catalog page offers a thumbnail listing of all display advertisements available for publishing. The Master Catalog page also shows a visual image of the advertisements on the left side of the screen and what copy is included in each advertisement on the right side of the Master Catalog page. Prior publication determines what step in the ordering process to which the user will be linked. If the advertisement has previously been published, the user is linked to the Previous Insertions page. If the advertisement has never been published before, the user is linked to the Select Copy page. To select an advertisement for possible publishing, the user clicks on the thumbnail view located on this page. The user will be connected to the appropriate page according to the specifications mentioned above.

Previous Insertions

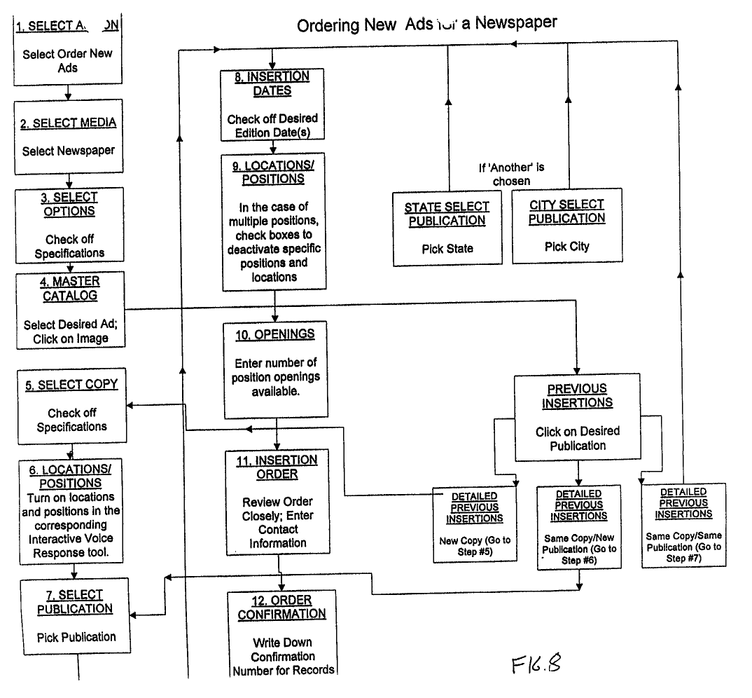

On the Previous Insertions page, shown at FIG. 9, a table showing text included within the chosen advertisement, as well as the history of its placement, appears. The table headings are as follows:

Copy—The actual text that appears in the advertisement.

Publication—A list of newspapers in which the advertisement has previously been placed.

The publications listed are linked to the Insertion Dates page. If the user would like to republish the corresponding advertisement in the newspaper listed, the publication link is clicked.

Date—The date the advertisement was placed in the corresponding publication.

Cost—The cost of the advertisement.

Resp.—The number of responses the advertisement generated in the corresponding publication.

Qual.—The number of qualified responses the advertisement generated in the corresponding publication.

Cost Qual.—The total advertisement cost based on how many qualified responses were generated.

More—Contains links for each corresponding advertisement, which are connected to a page with detailed information pertaining to each advertisement. See diagram on page 10.

The left margin of this page contains links that offer multiple options. The options are explained as follows:

Show All Orders: This option is the default setting. It allows all orders that have been previously inserted to be viewed.

Show Only My Orders: Shows only the orders that have been inserted under the current User ID.

Order by Date: Lists the advertisements in ascending order by date.

Order by Number Qualified: Lists the advertisements in descending order based on the number of qualified responses per advertisement.

Order by Cost/Qualified: Lists the advertisements in ascending order based on the cost of the advertisement per qualified response.

Hide Copy: Removes the advertisement text from the publication listing. Doing so will condense the list.

Set Date Range: Performs a more concentrated search based on a specific range of dates.

This link is connected to the Previous Insertions shown at FIG. 9.

The Detail Results page, shown at FIG. 10, which is accessed through the “More” option on the Previous Insertions page, offers a more descriptive look at a previous advertisement. The Detail Results page lists the placement results for individual locations. The Detail Results page contains information about the time period, the publication, the cost of the advertisement, and the amount of responses. The headings are explained as follows:

Period: The amount of time the advertisement was in publication.

Publication: The newspaper the advertisement was published in for the specified time period.

Publication Date: The date the advertisement was published.

Expire Date: The date the advertisement order expired.

Advertisement Cost: The total cost of the advertisement for the time period and publication listed.

Location: If the advertisement was placed for multiple locations, then each location will appear showing the amount of total responses and the amount of qualified responses per location.

Total: The combined amount of responses and qualified responses.

Previous Insertions: Date Range

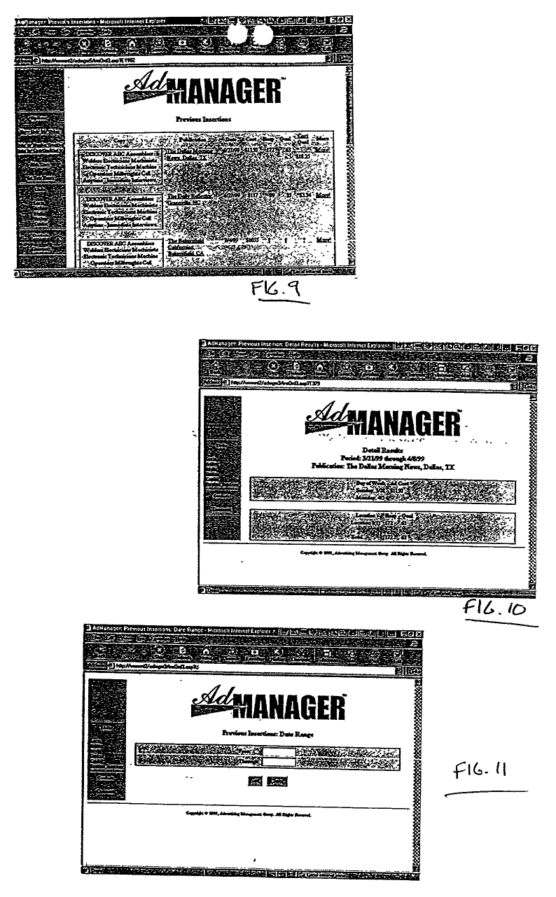

The Previous Insertions: Date Range page, shown at FIG. 11, which is accessed through the “Set Date Range” option on the Previous Insertions page, allows the user to perform a search for previously inserted advertisements based on a specific range of dates. To activate the search, the user enters the begin and end dates (in MM/DD/YY format) of the search in the specified text fields located on this page.

Individual Previous Insertion Page

Once the user has determined the advertisement to place, they can click on one of the links located under the Publication heading in the table. Clicking on a specific publication will take the user to that particular advertisement's individual Previous Insertion page, FIG. 12, for that newspaper. From this page, the user has the opportunity to re-run the same advertisement in that particular publication.

If the user decides to rerun the same advertisement, they can click on the Same Copy/Same Pub button, which will connect the user to the Insertion Dates page. If the user chooses to change the publication, the user can click the Same Copy/New Pub button. If the user chooses to change the content of the advertisement, the user can click on the New Copy button, which will connect to the Copy or Publication Change page described below. These Web pages are explained in detail in the following sections.

Select Copy

Some advertisements will contain drop down menus, check boxes, editable text, and fixed text as shown in the Select Copy page shown at FIG. 13. The drop down menus allow the user to choose positions and locations for the advertisement. Positions will coincide directly with an advertisement's existing interactive voice response (IVR) script. To select more than one choice, the control key is held down while clicking. The check boxes allow the user to choose which items to appear in the advertisement.

The editable text boxes offer the ability to make changes to areas of the advertisement that may vary. All changes are checked for any grammar or spelling mistakes prior to release to the newspaper. Text that may be part of the advertisement artwork or mandated to stay constant from advertisement to advertisement can be controlled as fixed text and cannot be changed or manipulated by the user, such as the contact telephone number, a web site address, or logo. Upon publication, a unique identifier is assigned to each specific advertisement in, for example, an extension number for the IVR system so that responses to that particular advertisement can be coordinated to determine the effectiveness of the advertisement. Other types of unique identifiers can be assigned such as a web site URL or web site passwords so that responses to advertisements over the internet can be coordinated according to the particular advertisement. Any other type of unique identifier could also be used to identify responses to particular advertisements. Once the Select Copy options are chosen, the advertisement is produced and a proof copy of the advertisement will be sent to the user prior to its release for publication.

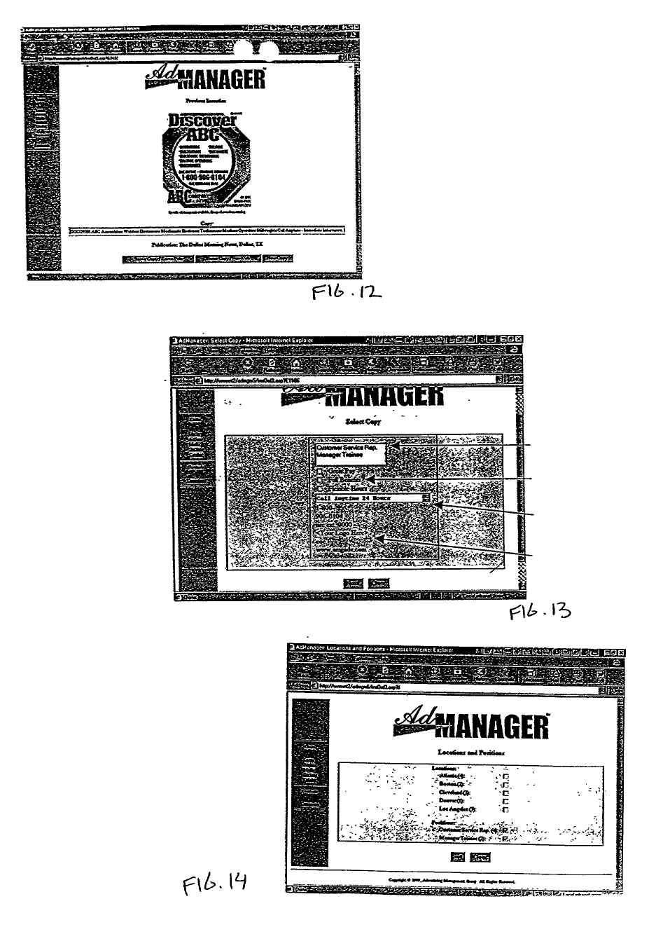

The Locations and Positions page, shown at FIG. 14 (a multiple locations Location and Positions page is shown at FIG. 20), allows the user to control which facility locations to be made available to respondents, along with the positions available at those locations. The table on this page contains check boxes for all available locations. The user can select individual or multiple locations by clicking on the check boxes. The table also contains check boxes for all available positions for the specified advertisement. Select individual or multiple advertisements by clicking on the check boxes.

The Select Publication page, shown at FIG. 15, allows the user to perform general or specific searches for publications. The initial search page offers a publication drop down menu to select a previously used publication or a new publication. Selecting a publication from the list will take the user to the Insertion Dates page. If the user selects “Another” from the list, then they will be connected with the “State” Media Search page.

The “State” Media Search page, shown at FIG. 16, offers three fields to enter or select information. The fields are as follows:

Name—Enter the name of a specific publication or a word or phrase to search for matching publications. For example, enter “Times” to search for publications that contain the word “Times” in the title.

Media—Select the type of newspaper to search for from the drop down menu. To include all types in the search, select “All”.

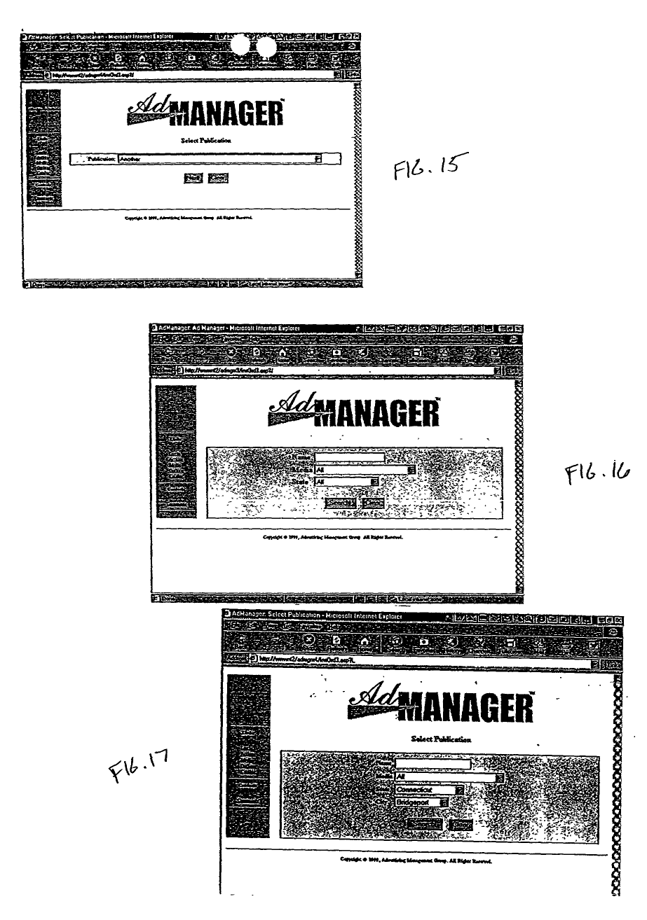

State—Select the specific state in which to perform a search from the drop down menu. To include all states in the search, select “All”. Selecting a specific state will access “City” Media Search page, shown at FIG. 17, that contains a drop down list of cities for the specified state. Select a city from the list or include all of the cities by selecting “All”.

This page also allows the user to perform a more focused city search. The user can select the specific city to perform the search in from the drop down menu. To include all cities in the search, select “All”. Select a specific city from the drop down menu to begin the search. Once a media search is performed, the Outlets page, shown at FIG. 18, will open. This page lists all of the publications that conform to the search requirements. If there are multiple pages acquired by the search, links exist in the left margin to navigate between the pages. The links are explained as follows:

First: Return to the first page of the list.

Next: Go to the next page of the list.

Previous: Go to the preceding page of the list.

Last: Go to the last page of the list. Then, click on the desired publication to place an advertisement in a particular publication from the list of existing publications. Doing so will open the Insertion Dates page.

Insertion Dates

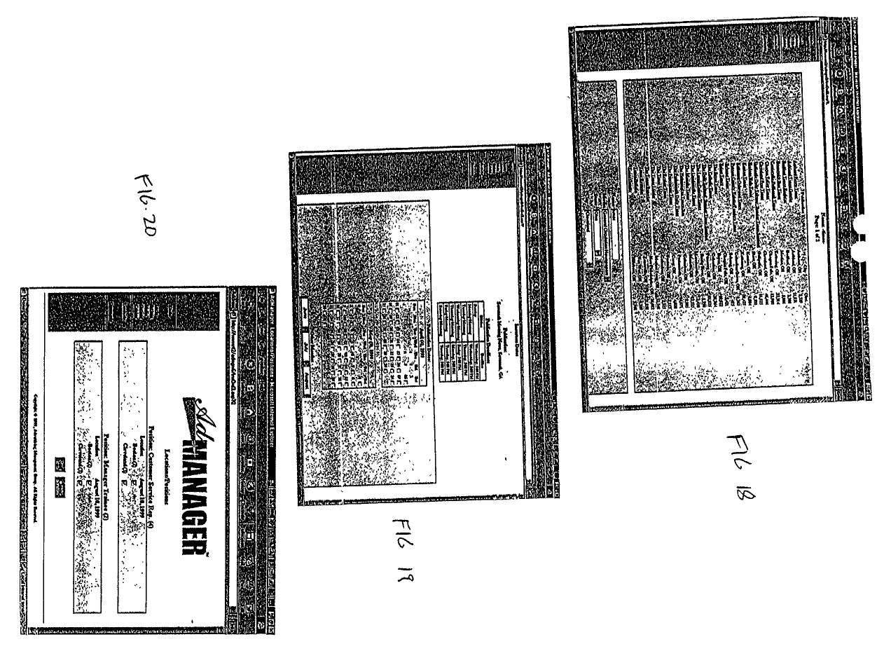

The Insertion Dates page, shown at FIG. 19, allows the user to select the publish date(s) for the desired advertisement. This page shows the publication that has been selected, the publication deadlines, and selection boxes for selecting dates. Other months are also shown. To select another month, click on the corresponding button. The user can select the publication dates by clicking on the selection box located to the right of each available date. The Insertion Dates page is set up in a manner that allows the user to select only the dates that correspond to that newspaper's editions. Note: Dates listed in red may be past the publication deadline. Dates listed in green can still be selected for publication.

Once all of the appropriate dates have been selected, the user can click the “Next” button to access the Locations/Positions page. Selecting multiple locations from the Locations and Positions page will access the Locations/Positions page. This page is used for determining which location(s) will be active when the advertisement is published. For example, if the user has a customer service position available in a Boston location, and not in a Cleveland location, the Boston selection box is clicked to activate that location for the advertisement. The user can then click the Set button to access the Openings page.

The Openings page, shown at FIG. 21, lists the Positions and Locations chosen. For each location, the user can enter the number of openings available for each location.

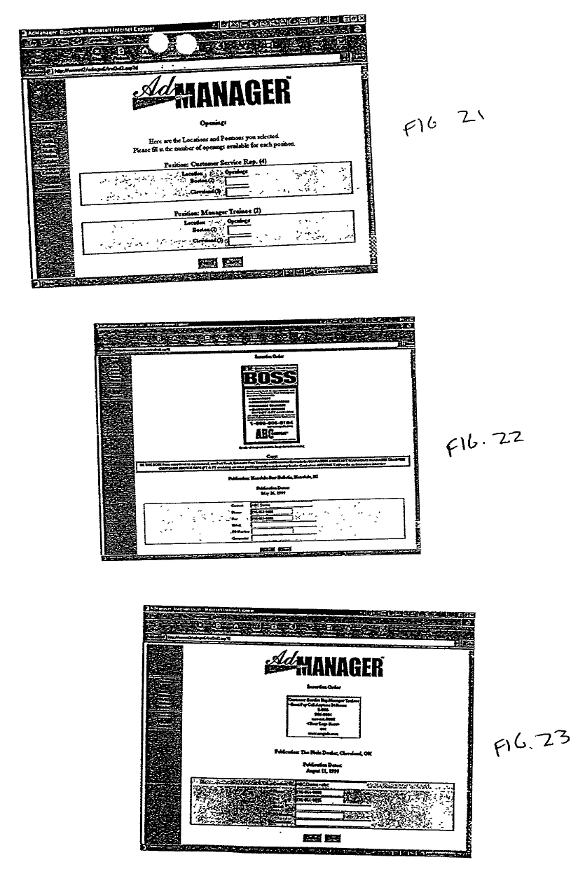

The Insertion Order page, shown at FIG. 22, shows the final version of the advertisement as it will be placed in publication (an Insertion Order page for an In-column is shown at FIG. 23). The table below the advertisement contains the final information designated through prior menu options. The headings listed are explained as follows:

Copy—The text as it will appear in the final advertisement, including any editing or changes that have occurred.

Publication—The newspaper the advertisement will appear in.

Publication Dates—The dates selected for publication.

Contact—The contact name should be entered in the space provided.

Phone—The contact phone number should be entered in the space provided.

Fax—The contact fax number should be entered in the space provided.

E-mail—This field is optional. If the user would like to receive an advertisement proof via e-mail, an e-mail address can be entered in the space provided. Otherwise, an advertisement proof will be sent via fax.

P.O. Number—The purchase order number should be entered in the space provided.

Comments—Any additional comments pertaining to the placement of the advertisement should be entered in the space provided. For example: a preferred publication section, a request for additional information, etc.

The Contact, Phone, Fax, and P.O. Number fields are required. These fields are used to send advertisement proofs and to provide contact information to advertisement developer if questions should arise regarding the placement and/or ordering of an advertisement. If the user has placed the wrong information in the insertion order, they can click Clear and enter the correct information. If everything has been entered correctly, the user can click Order. The user will be connected to the Order Confirmation page.

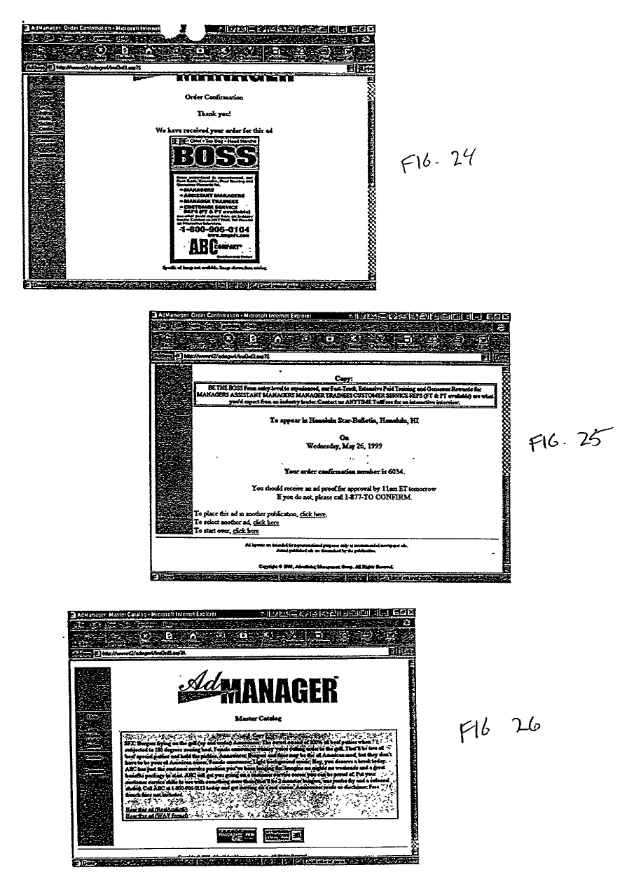

The Order Confirmation page, shown in FIGS. 24 and 25, confirms the order. This page shows the format of the advertisement chosen, the text that is to appear in the advertisement, what publication it will appear in, and the dates it will appear. The Order Confirmation page will also give the user a confirmation number. The confirmation number is essential in assuring that the order has been placed and confirmed. This page also lists a toll free hotline number if anything should occur affecting the confirmation of an order.

Links are available at the bottom of the Order Confirmation page if the user would like to place the advertisement in another publication, select another advertisement all together, or start the entire process over.

If the user decides that another media environment is the best way to get their message across to their audience, the desired media environment link located in the Select Media page can be clicked. The ability to manage, edit, and create advertisements corresponding to all media environments is similar to the description identified above for managing, editing, and creating advertisements in a newspaper. The transfer of artwork, audio files, video files, and other media information can be uploaded through the internet or transferred to the advertising developer. The developed advertisement can viewed directly on the web site for confirmation. Available radio advertisements can be heard through RealAudio Player or in a WAV format to help choose the desired advertisement. Available television commercials can be seen with the use of RealVideo Player or in an AVI format.

Other advertising options are available utilizing this invention such as billboards, posters, banners, on-line postings, and direct mailings. Each of these types of media environments can be ordered through the advertising manager web site and created and viewed directly on the web site.

Check Order Status

The Check Order Status page, shown at FIG. 32, allows the user to view all orders that have been placed (specific order status page at FIG. 33). If this is the first time that a user is ordering an advertisement, this action is not necessary. The advertisement manager production process is a completely interactive process between the user and the actual advertisement production facility. Each order requested on the part of the user is immediately transferred to the production ad traffic system in the confines of the fulfillment vendor. Here the order resides within the “Task List”—each task representative of the various stages of actual advertisement production, which are respectively: space reservation, cost estimating, ad sizing, ad creation and/or revision, quality checking, client review and approval and ultimately, delivery to the media, response reporting after publication, actual ad costing and finally, tear sheet delivery. The Traffic Controller distributes the orders to the production department, where each task, once completed, is reported back to the client through the Check Order Status. The automation of this production process allows for an instant tracking capability of any order within the process, through the instant order tagging methodology. It also allows deadline control of each order, as the publication database impacts each order when selected through the ordering process by the user. This allows manipulation of an essentially “first-in, first-out” advertisement product process to be instantly adjusted to the various newspaper deadlines as deadlines approach.

To access this screen, the user clicks on the Check Order Status link located on the Select Action page. The Check Order Status page contains the order number of the advertisement, the next activity that is to be performed within the placement process, the publication that the advertisement was placed in, and the insertion date.

The tasks that appear under the Next Activity heading in the Ad Manager are explained as follows:

Acknowledge Order—the assigned advertisement manager resource will acknowledge the order. During office hours, the order is acknowledged within minutes.

Send Proof—The advertisement proof will be sent to the user and will await their authorization. The production staff is able to automatically duplicate the catalog ad and make changes according to the user's copy selections. Display ads are created in GIF and PDF format so the user may see the ad online. In-column ads are tagged appropriately for the corresponding publication.

Await Authorization—the advertising manager is awaiting the user's authorization to place the proof. The user will click on the “Await Authorization” link that will allow them to view their ad, cost estimate and authorize the ad immediately or choose to make changes online.

(See Ad production process Flowchart shown in FIG. 7).

Reserve Space—the production staff can reserve space automatically by faxing a reservation via the advertisement manager using the information in the outlet database.

Confirm Space—The newspaper can call an Auto-Confirmation line that automatically turn the task for the user, acknowledging that the newspaper received the space reservation.

Send Advertisement—the advertising manager will automatically export information for use in the Associated Press' software called AdSend, expediting the delivery to the production.

Confirm Advertisement—The newspaper can call the Auto-Confirmation line that will automatically turn the task for the user, acknowledging that the newspaper received the advertisement successfully.

Tear Sheet Received—the advertising manager will receive the tear sheet from the newspaper.

Tear Sheet Sent—The tear sheet will be sent to the user.

Complete—The advertisement proof has been completed.

To view the status of specific advertisements, the user can click on the corresponding Order number. This link is attached to a subsequent Order Status page, shown at FIG. 33 (general Order Status page at FIG. 32), for the desired advertisement. Once the user has finished viewing the order status of a specific advertisement, they can click on the “Return to the Order Status page” link. Doing so will take the user back to the Order Status page where they have the option of viewing other advertisements or returning to the Select Action page.

Current Week's Results

The Current Week's Results page, shown at FIG. 34 (individual advertisement's current week's results shown at FIG. 35), presents information on all advertisements that have been published the week prior to the current date. The user has the ability to view individual advertisements' results as well. This page allows the user to place advertisements and use advertising expenses more effectively. The information presented allows the user to view the success rate of the advertisements in specific areas based on the number of qualified responses and the cost of the advertisement per qualified response. From this information, the user can make better decisions when considering reordering advertisements that were not as successful.

Information on this page includes the following:

More Information—Links for each corresponding advertisement, which are connected to a page with detailed information pertaining to individual advertisements. See diagram on p. 40.

Publication—A list of newspapers that the advertisements have been placed in over the past week.

Dates—The dates that the advertisements were placed in the corresponding publications. Note: all dates that advertisements were placed will be listed.

Cost—The total cost of all the advertisements placed per publication.

Total Response—The total number of responses that the advertisements generated per publication.

Total Qualified—The number of qualified responses that the advertisements generated per publication.

Cost/Qualified—The total amount that the advertisements cost based on how many qualified responses were generated.

Future Insertions—All of the advertisements that have been ordered per publication.

To reorder an advertisement from this page, the user can click the selection box that corresponds to the desired advertisement; then click the Place Order button. This will take the user to the Insertion Order page.

Placement History

This action offers a detailed account of all advertisements that have been placed, including comprehensive decision support information about the success and cost of the advertisement. To access this page, the user can click on the Placement History link located on the Select Action page. Click on the link to access the Select Media and Selection Options pages. Refer to the Select Media and Selection Options sections for information about these pages.

Select Insertion Dates

Once the user selects desired options, they will arrive at the Select Insertion Dates page shown at FIG. 36. This page allows the user to perform a search for advertisements placed during a specific period of time. Enter the begin date (in MM/DD/YY format) of the search in the “From” text field and enter the end date (in MM/DD/YY format) of the search in the “Through” text field. When the dates have been entered, click the “Next” button to access the Select Publications page.

Select Publications

The Select Publications page, shown at FIG. 37, lists all of the publications showing advertisement placement during the specified time frame. Select a publication by clicking on the corresponding selection box and clicking on the “Next” button. Doing so will take the user to the Select Advertisements page.

Select Advertisements

The Select Advertisements page, shown at FIG. 38, lists all of the advertisements that have been published in the selected publications. To select an advertisement, the user can click on the corresponding selection box and click on the “Next” button. Selecting an advertisement will connect the user to the Placement History page.

Placement History

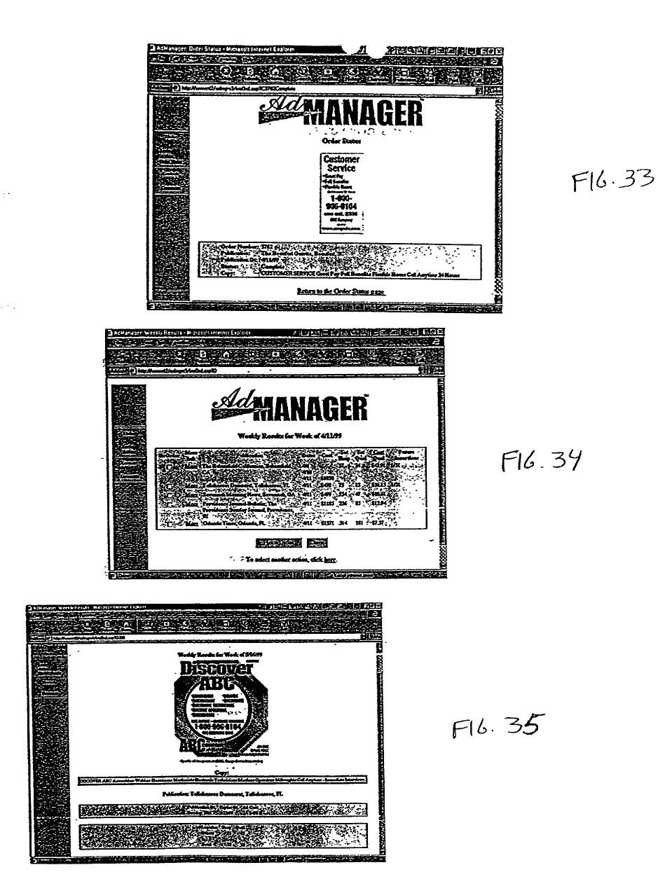

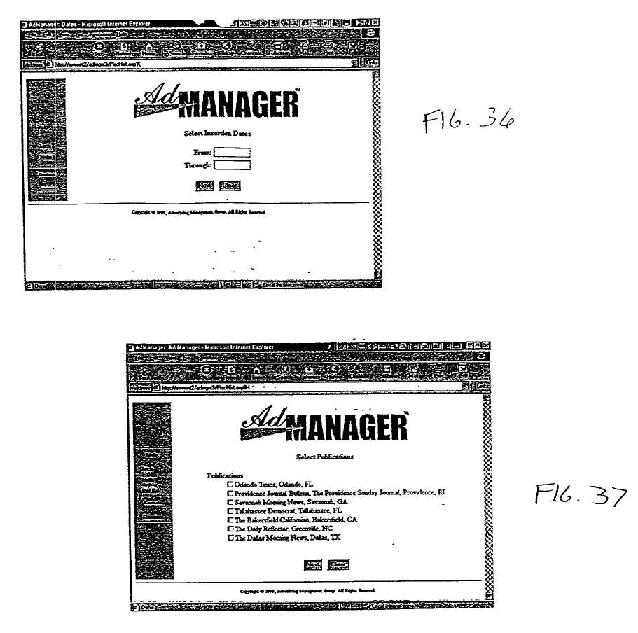

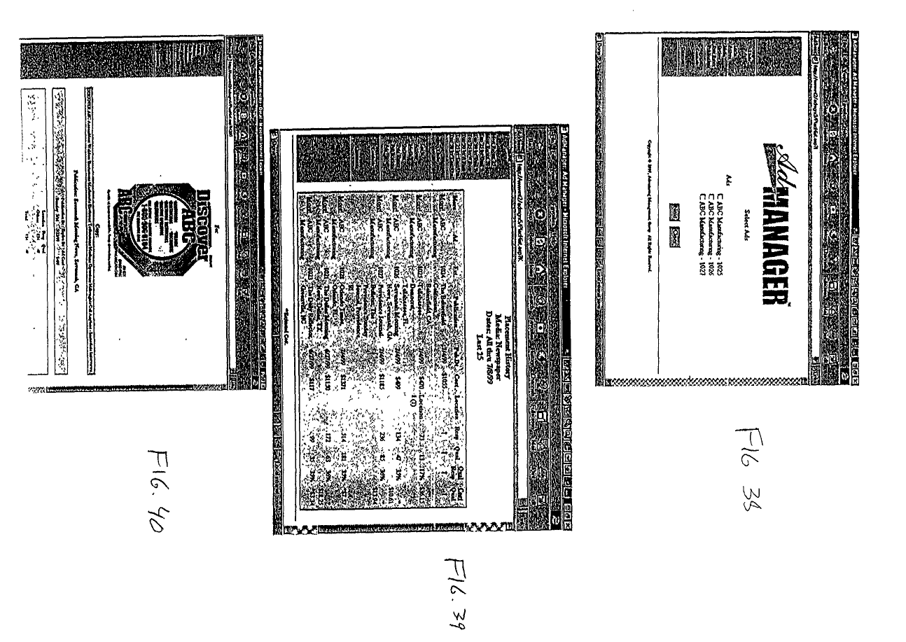

The Placement History page, shown at FIG. 39 (individual placement history is shown in FIG. 40), shows the results from the advertisement specified in the Select Advertisements page and all of the publications that each selected advertisement has been published in. Links are located in the left margin. The links allow the user to list the advertisement placements in specific categories. The categories include most recent 25 placements, most recent 50 placements, the top 25 by qualified responses, the top 50 by qualified responses, etc. This page also includes a link that allows the user to view the selected advertisement's information based on an individual publication. This subsequent page also contains an image of the advertisement as it was placed in the publication.

After the user coordinates, creates, and places the advertisement using this invention, a prospective job applicant can contact utilize a response system encompassing IVR and/or web-based pre-qualification screening which allows a job applicant to respond to the advertisement by submitting information regarding pre-qualification or screening criteria. As explained above, the response system could include utilization of a telephone IVR system or response via a designated web site. The unique identifier (assigned to or input into the system) which coordinates the responses to particular advertisements can be assigned as specific extension numbers to the IVR system contact number or as a web site URL. This unique identifier enables the invention to match responses to the advertisement with the results of pre-qualified respondents.

The response system can utilize any type of screening questions required by the user to determine the preliminary qualifications of the prospective job applicant and the applicant can receive immediate feedback regarding their preliminary qualifications. If the prospective job applicant responses to the screening questions do not meet the minimum requirements of the user, the user is not burdened with reviewing these responses. Only prospective job applicants meeting the minimum requirements based on the screening questions are forwarded in a report to the user for scheduling of further interviews. If the user coordinates an interviewing schedule prior to placing the advertisement, and if the prospective job applicant meets the minimum requirements of the screening process, an interview could be scheduled immediately upon the completion and review of the responses from identified available interview dates.

While various embodiments of this invention have been disclosed, it should be understood that modifications and adaptations thereof will occur to persons skilled in the art. Other features and aspects of this invention will be appreciated by those skilled in the art upon reading and comprehending this disclosure. Such features, aspects, and expected variations and modifications are clearly within the scope of the invention, and the invention is limited solely by the scope of the following claims.

Having thus defined the invention, we claim:

1. A method for managing advertisements comprising:
a database for receiving responses to published advertisements;
assigning published advertisements a unique identifier whereby responses can be identified as resulting from a particular advertisement;
providing a response system in communication with said database, said response system capable of transmitting pre-qualification questions to a remote source and receiving responses to said pre-qualification questions; and
determining the effectiveness of a particular published advertisement based on the number of responses associated with each said unique identifier.

2. The method of claim 1 further comprising means for ordering the publication of additional advertisements based on the effectiveness of a particular published advertisement.

3. The method of claim 2 further comprising the step after determining the effectiveness of a particular published advertisement of modifying non-effective published advertisements for later publication in order to attract the desired number of responses.

4. The method of claim 3 wherein said method can be utilized to manage advertisements in a number of media environments, including but not limited to, newspaper, radio, television, billboard, poster, direct mail, and internet advertisements.

5. The method of claim 1 wherein said response system is an interactive voice response system.

6. The method of claim 1 wherein said response system comprises the internet connection of an remote computer with said database.

7. A method for managing advertisements comprising:
utilizing a searchable database containing published advertisements, said database accessible by a user;
choosing the media environment desired for a proposed advertisement;
searching said database for prior published advertisements in said chosen media environment;
selecting a prior published advertisement and performing any modifications required for the proposed advertisement; and
assigning each published advertisement a unique identifier whereby responses can be identified as resulting from a particular published advertisement.

8. The method of claim 7 wherein said media environment is chosen from the group consisting of, but not limited to, newspaper, radio, television, billboard, poster, direct mail, and internet environments.

9. The method of claim 8 further comprising prior to selecting a prior published advertisement, determining the effectiveness of any identified prior published advertisements based on the number of responses associated with each unique identifier.

10. The method of claim 9 further comprising after selecting a prior published advertisement and performing any modifications required for the proposed advertisement, selecting the advertising avenues within each media environment, such as the particular newspaper or radio station, in which the advertisement is to be published.

11. The method of claim 10 further comprising responding to a particular published advertisement utilizing the unique identifier as a web site password.

12. The method of claim 10 further comprising responding to a particular published advertisement utilizing the unique identifier as a number extension for a telephone number.

13. A method of managing job placement advertisements comprising:
utilizing a searchable database containing published job placement advertisements wherein all published job placement advertisements have a unique identifier whereby responses thereto can be identified as resulting from a particular job placement advertisement, said database accessible by a user;
choosing the media environment desired for a proposed job placement advertisement;
searching said database for prior published job placement advertisements in said media environment;
determining the effectiveness of a particular published job placement advertisement based on the number of responses associated with each said unique identifier;
means for selecting the advertising avenues to be used within each media environment, such as the particular newspaper or radio station, in which the proposed advertisement is to be published; and
means for ordering the publication of additional job placement advertisements within the specific advertising avenues.

14. The method of claim 13 further comprising after determine the effectiveness of a particular published job placement advertisement based on the number of responses associated with each said unique identifier, selecting a prior published advertisement and performing any modifications required for the proposed advertisement.

15. The method of claim 14 wherein said media environment is chosen from the group consisting of, but not limited to, newspaper, radio, television, billboard, poster, direct mail, and internet environments.

16. The method of claim 15 wherein said advertising avenues comprise the particular media source chosen for use within the identified media environment such as the particular newspaper, particular radio station, or particular television station specified for the advertisement.

17. An advertising management system comprising:
a database for receiving responses to advertisements, said advertisements having unique identifiers associated with each published advertisement whereby responses identifying said unique identifier can be attributed as resulting from a particular advertisement; and
a response system in communication with said database, said response system capable of transmitting and receiving data between said database and a remote source, wherein said database can communicate requested information to said remote source and receive information responses from said remote source.

18. The system of claim 17 further comprising a compiling system which coordinates all responses to a particular advertisement as to whether the responses qualify based on a predetermined criteria for responses.

19. The system of claim 18 wherein said response system is an interactive voice response system.

20. The system of claim 18 wherein said response system comprises said database in communication with a plurality of remote computers.

21. The system of claim 20 wherein said response system comprises communication on the internet.

22. An screening system for coordinating pre-qualification responses to job placements advertisements, said screening system comprising:
a database for receiving responses to job placement advertisements, said job placement advertisements having unique identifiers associated with each published advertisement whereby responses identifying said unique identifier can be attributed as resulting from a particular job placement advertisement;
a response system in communication with said database, said response system capable of transmitting pre-qualification questions to a remote source and receiving responses to said prequalification questions; and
a compiling system which compares the responses to said pre-qualification questions to predetermined, preferred responses in order to determine if the applicant is initially qualified for the advertised job.

23. The system of claim 22 wherein said response system is an interactive voice response system.

24. The system of claim 22 wherein said response system comprises said database in communication with a plurality of remote computers.

25. The system of claim 24 wherein said response system comprises communication on the internet.

26. The system of claim 22 wherein the effectiveness of the advertisement is determined based on the number of qualified responses to the advertisement.

27. The system of claim 26 further comprising an advertisement re-ordering system wherein advertisements which attract the preferred number of qualified applicants and be reordered for future publication.

28. The system of claim 27 wherein said re-ordering system can indicate the specific publication to be used.

29. The system of claim 27 wherein said re-ordering system can indicate the specific dates upon which the advertisement is to run.

30. The system of claim 27 further comprising means for modifying uneffective advertisements based on the user's particular specification.
